(19) United States
(12) Patent Application Publication
(10) Pub. No.: US 2016/0278303 A1
(43) Pub. Date: Sep. 29, 2016

(54) Horticultural Plant Bending Apparatus

(71) Applicant: Brady Calsbeek, Glenwood Springs, CO (US)

(72) Inventor: Brady Calsbeek, Glenwood Springs, CO (US)

(21) Appl. No.: 14/670,330

(22) Filed: Mar. 26, 2015

(51) Int. Cl. A01G 9/12

(52) U.S. Cl. CPC A01G 9/12

(57) ABSTRACT

The bending apparatus assists growers by bending the canopy over giving more light to the lower parts of the plant. The end result makes for bigger and more vigorous plants because more light reaches more parts of the plants that typically would be cut off in traditional horticulture. By simply tying string to the plant down to the ladder and to the clothesline tightener, the user is able to have complete control over the plants growth. The ability to lower the canopy at a slower rate than just tying the plant down is what really sets my invention apart from all the others. The ladder and clothesline tightener is what gives the user complete control over their plant and how they want the plant to grow.

### DESCRIPTION OF THE PARTS OF THE INVENTION

The parts of the invention include string, a clothesline tightener/winch and the ladder/arm with rungs.

1. Clothesline tightener—The purpose of this mechanism is to adjust tension on the plant via string(s) to whatever part of the plant that is being bent/trained. As you turn the handle on the clothesline tightener it will reel in the string thus bending/training whatever it is tied to. The turning handle acts as a one directional ratchet that turns and clicks like a gear while holding the tension on the string as it is reeled in.

2. Ladder/Arm with rungs—This part acts as a track for the string to go from the plant to the clothesline tightener. The ladder gives the user different options as far as what direction the plant will be bent. The rungs on the ladder act as an anchor point for the string which will give many different options for what part of the plant is being bent and for whatever angle is desired. Also, for the square shaped ladder there are rings at the corners of the ladder to help keep the string on track to the clothesline tightener.

3. String—This part is for connecting the plant to the clothesline tightener. The string is tied around the plant stem, branch, or any part of the plant you want to train and bend. It is then threaded around a rung on the ladder and then tied to the clothesline tightener. String can also be used to “anchor” the plant by tying it from the base of the plant to the side of the growing container.

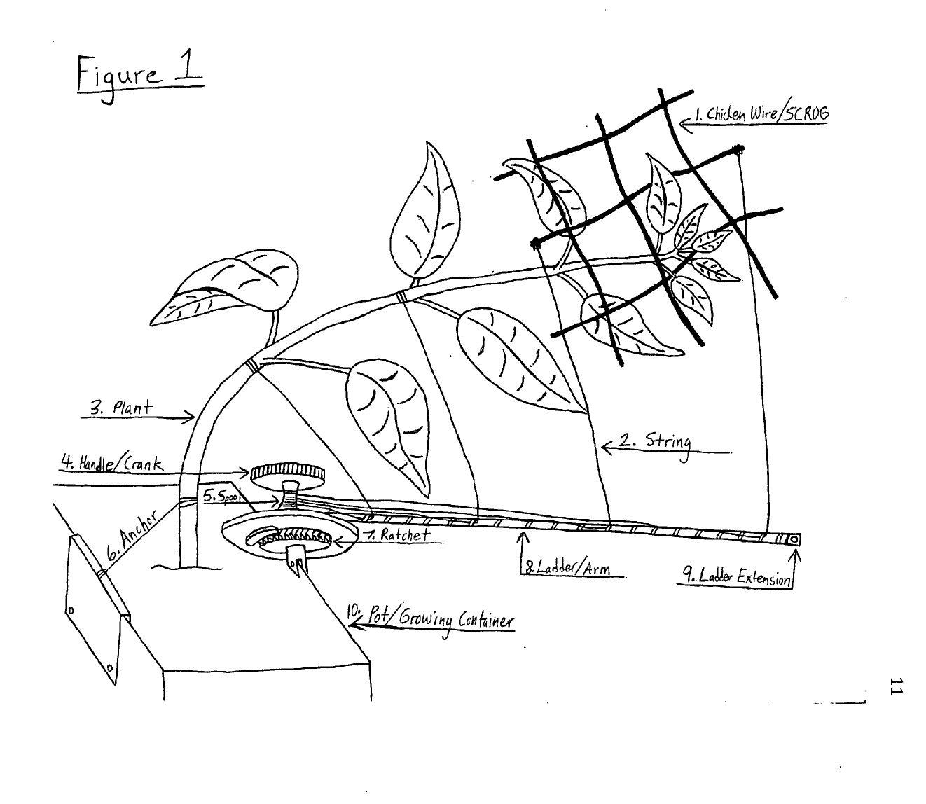

FIG. 1 on pg 11 shows the bending apparatus tied to the plant with multiple strings.

Numeral 1 shows the chicken wire that the user can use to control large sections of the plant by attaching a net-like material (i.e. chicken wire or netting). Numeral 2 shows where the string is tied from the plant or chicken wire to the bending apparatus to control tension. Numeral 3 shows the plant and where it is placed in reference to the apparatus. Numeral 4 shows where the clothesline tightener is attached to the ladder which is attached to the growing container or placed in the medium the user is growing in. Numeral 5 shows where the spool on the tightener is located which is where the string is wrapped around. Numeral 6 shows where the user can anchor the plant using string to give more stability. Numeral 7 shows the ratchet mechanism that helps hold the tension on the string from releasing. Numeral 8 shows the ladder from which the string goes from the plant and looped through one of the rungs on the ladder then to the clothesline tightener. Numeral 9 shows where the ladder can be extended if the user wishes to continue training the plant further. Numeral 10 shows the container that the plant is grown in.

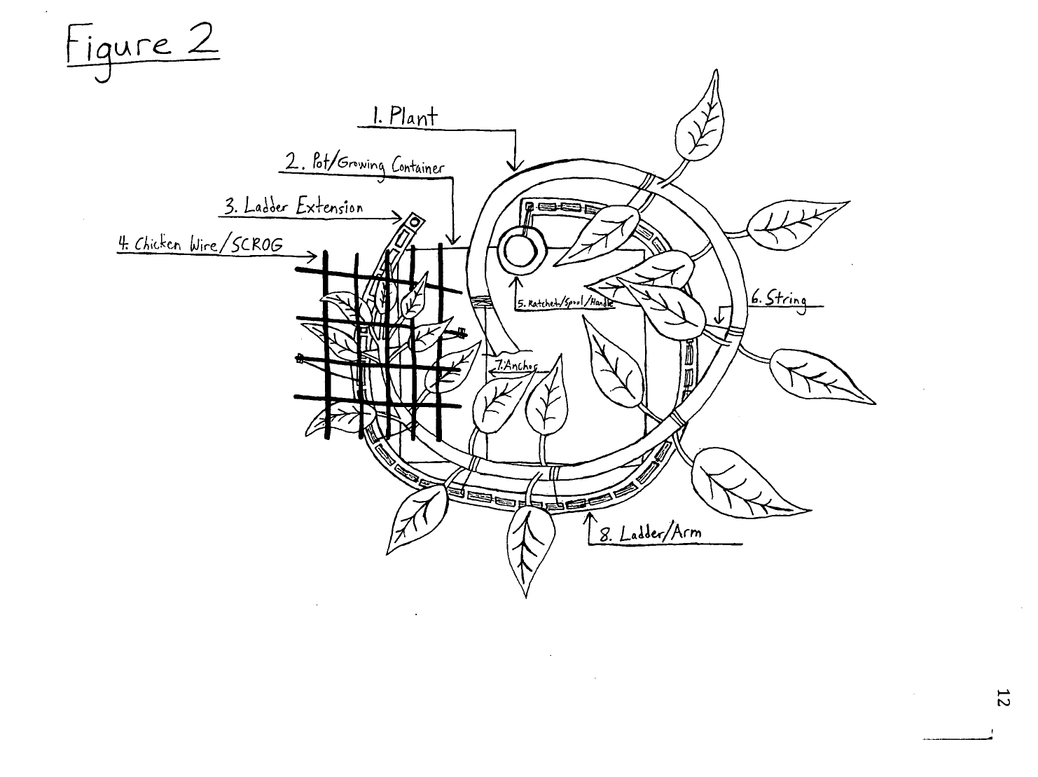

FIG. 2 on pg 12 shows the curved version of the bending apparatus from an aerial view. Numeral 1 shows the growing container. Numeral 2 shows again where the ladder can be extended for further training of larger plants. Numeral 3 shows the chicken wire or netting that can be used to control large sections of the plant. Numeral 4 shows the clothesline tightener device with each component being the ratchet mechanism, spool, and handle. Numeral 5 shows the string being tied from the plant or chicken wire which is then looped through the ladder and finally tied to the clothesline tightener. Numeral 6 shows the anchor for which the user can tie string from the base of the plant to the side of the growing container for more stability. Numeral 7 shows the ladder/arm for which the string is looped through from the plant to the clothesline tightener.

### DESCRIPTION OF OVERALL STRUCTURE OF INVENTION

The overall structure of the bending apparatus will come in two versions—a version for single plant training/bending and a commercial version for bending many plants at one time with a single clothesline tightener or winch. The single plant version consists of the clothesline tightener which is placed next to your plant and the ladder/arm is attached to this. The device will come in various shape options such as a spiral shape that curves around your plant and furthermore the user can even change the ladder to custom shapes depending how the plant will be trained/bent. The commercial version will consist of a single clothesline tightener or winch that is placed at the end of a row of plants and then a straight ladder is attached to it. Next the ladder is placed between so that it moves along the rows of plants. Then a string is tied to each stem of the plants in the row and threaded around a corresponding rung on the ladder next to each plant. After each string is threaded around a rung, it is pulled back and tied to the clothesline tightener or winch. As the winch or clothesline tightener is turned/cranked the string is reeled in therefore bending over each plant in the row.

### RELATIONSHIP BETWEEN THE PARTS OF THE INVENTION

The clothesline tightener/winch mechanism is the main part of the invention that controls the tension on the string, thus controlling how much the plant is bent. The clothesline tightener has a handle/knob at the top that is turned and acts like a one directional ratchet; meaning as you crank it it will turn and reel in the string on the spool portion of the device. The ladder is the part that connects to the clothesline tightener and gives the user options for what direction you want to bend/train the plant. The rungs on the ladder give different anchor points on the ladder for the string to thread around and tie back to the clothesline tightener. For ladder shapes with sharp angles like the spiral or square shape, there will be loops at the corners for the string to stay on track back to the clothesline tightener. The bending apparatus can be set at the base of the plants or can be staked into the medium for more stability.

### DESCRIPTION OF HOW THE INVENTION OPERATES/FUNCTIONS

After placing the bending apparatus at the base of the growing container the user has the option to first “anchor” the plant in the opposite direction you want to bend. You can do this by tying a string to the base of the plant's stalk and tie it tight and secured to the side of your container. This will keep the plant from uprooting from being bent over/pulled in the opposite direction. To start the bending process, a single string will then be tied to the desired part that the user wants to bend/train. The string is then threaded through a rung on the ladder/arm next to the plant and then tied to the clothesline tightener. This is where the phrase “Click a Day” comes into play. You will turn the handle/knob on the clothesline tightener which makes the ratchet and spool turn causing the string to be reeled in slowly thus pulling the plant down. As the plant grows, the user will attach more strings to new growth to keep it low growing and low stress trained therefore making the plant grow horizontally and parallel to the ladder/arm. Once the bend on each section of the plant is achieved you can either cut that string or tie a separate string from the same spot at the node to the rung that way it holds tension in that area. If you cut the string, the strings tied above the cut one will hold the tension and keep the plant in the same horizontal position and the plant will slowly be pulled down towards the ground and begin to grow in a horizontal direction parallel to the ladder/arm. The commercial version works essentially the same way, but with only one or two strings tied to each plant instead of multiple strings like the single plant version. This version has a clothesline tightener that is placed at the end of a row of plants. The ladder is then attached to the winch and placed between an entire row of plants followed by string being individually tied to each stalk in the row of plants. When you turn the handle/knob on the winch each plant in the row is bent over simultaneously.

### UNIQUE FEATURES OF INVENTION

A couple of the unique features include, but are not limited to, training large sections of a plant with chicken wire or netting and being able to change the shape and extend the ladder for additional training. The chicken wire is used for bending larger areas of the plant over at one time. You place the net/wire over your canopy and tie string to both sides of the chicken wire. The strings, tied to both sides of the wire, are then threaded through the rungs of the ladder. You then turn the handle on the clothesline tightener so that the whole section of chicken wire is pulled down towards the ladder. This will in turn pull down whole sections of the plant and greatly control the size and how tall the plant gets. The ladder/arm of the bending apparatus is adjustable so that the user can change the shape of the ladder in order to control what shape/direction the plant will be trained in. The curved/square version of the ladder/arm gives the user the ability to grow your plant in a circular shape around the growing container. The user will also have the option of attaching an extended ladder/arm for bending the plant further. This is so you can continue to grow the plant horizontally for however long you may want.

### HOW TO MAKE THE INVENTION

The invention is made by attaching a clothesline tightener or winch to the ladder. The clothesline tightener and winch are made from metal and consist of a one directional ratchet mechanism that allows for reeling in the string on the spool so that tension is held. The ladder portion of the device is made from aluminum rods with rungs that are screwed in from the sides. The single plant version with the square shaped ladder will have metal rings/hoops at the corners of the ladder so that the string can stay on track to the clothesline tightener. Aluminum stakes are optional if the user wants more stability so that the apparatus does not shift or move.

### OVERVIEW OF INVENTION

### Purpose of Invention

The purpose of the invention is to pull your plants down at a slow continual rate to achieve a growing technique known as Low Stress Training (LST). LST is where a low amount of stress is applied to a plant to where it's not enough to hinder the growth, but will train it to handle greater amounts of stress that it could encounter throughout its lifetime. This low amount of stress applied to the plant promotes more vigorous growth and stronger branches for holding large flowers, fruits, or vegetables. The invention also makes light penetration reach much more area on the plant promoting bigger and better yields. It also gives you the ability to grow bigger plants in small spaces.

### Brief Description of Invention

The bending apparatus is made up of a clothesline tightener (spool, ratchet mechanism, and turning handle/knob) which is placed on top of your growing medium next to the plant. After the desired shape of ladder is chosen, it is attached to the clothesline tightener. The user then has the option to anchor the plant by tying string to the base of the stem and then tied to the side of the growing container. String is then tied to whatever part of the plant you want to bend/train. It is then threaded around a rung on the ladder/arm and then tied to the clothesline tightener. As the user begins to “Click a Day,” just the right amount of low stress is put on the plant as it it bent over gradually. As the plant grows more, you attach more strings to the new growth and can continue bending new branches. The goal is to have multiple strings tied to the stalk to where the plant is growing low and horizontally. The commercial version is the same concept except the tightener is placed at the end of a row of plants with a straight ladder that runs between the row of multiple plants. With this layout, string is tied to each of the stalks of the plants in the row and threaded around a rung on the ladder next to each plant. After the string is threaded it is pulled back and tied to the winch. As the handle on the winch is turned every string attached to the plants in the row is reeled in thus pulling down every plant in that row simultaneously.

### Description of Problems Solved by Invention

This invention creates a safe way to bend your plants without the risk of snapping the plant or its branches. It will also promote more light penetration to the undergrowth of the plant thus creating bigger and better plants/yields. It will train your plant to handle more stress increasing the chances of a successful grow. By bending your plant down and making more space to grow, it will eliminate the need to trim down your plant which can slow or stunt growth.

How the Invention is an Improvement over Existing Technology: The invention improves the existing method of bending your plants by hand, which only bends your plant one time in its lifetime opposed to continually. Bending the plant continually throughout its lifetime will train it to handle more stress while making it grow stronger and more vigorous. The bending apparatus is also an improvement to a technique called Screen of Green (SCROG). Screen of Green is where growers place a net over their entire canopy and proceed to bend branches up and down through the net. By using this technique (SCROG) doesn't promote optimal light penetration to the entire plant because the top growth blocks light penetration to the undergrowth. The chicken wire/netting is also an improvement because you can still bend the branches up and down through it while also pulling the plant/branches down simultaneously. The commercial version makes it so you can bend over multiple plants in a row getting more light penetration to the under growth. This in turn makes it so you will have more lower growth reach the canopy and reach full maturity. Existing technology suggests to cut off all the lower growth to promote growth to the top. Using the bending apparatus, the user can cut out this step and save valuable grow time and money spent on nutrients by creating more tops on your flowering plant or fruits by bending them over.

### Benefits to Users of Invention

Users of the bending apparatus will be able to grow bigger, stronger, and more vigorous plants. The invention will also make cultivating taller growing plants in small spaces much easier. Flowers, fruit, and vegetables will be in much bigger yields because of the light penetration to the entire plant. Users also have a fail-safe way to bend their plants without the worry of breaking and killing the plant.

### IDENTIFICATION OF PARTS/COMPONENTS OF INVENTION

### Reference Numeral—Descriptive Name for Part

FIG. 1

1. Chicken Wire/SCROG

2. String

3. Plant

4. Handle/Crank

5. Spool

6. Anchor

7. Ratchet

8. Ladder/Arm

9. Ladder Extension

10. Pot/Growing Container

FIG. 2

1. Pot/Growing Container

2. Ladder Extension

3. Chicken Wire/SCROG

4. Ratchet/Spool/Handle

5. String

6. Anchor

7. Ladder/Arm

1. The bending apparatus is a ladder with a clothesline tightener attached to the end of it. The ladder and the rungs on the ladder acts as an anchor point for the string that goes from the plant to the clothesline tightener.

2. The clothesline tightener is the part of the apparatus that holds tension on the string while also tightening and reeling in the string at the same time. By tying the string to the clothesline tightener, the tightener handle is turned/cranked thus reeling in and tightening the string controlling how far the plant will be bent over at any given time.

3. The String that is tied to the plant is threaded through a rung on the ladder which is next to the plant. Multiple strings can be attached to different parts of the plant so that you can train any part of the plant at the same time.
